(19) United States
(12) Patent Application Publication
(10) Pub. No.: US 2004/0182953 A1
(43) Pub. Date: Sep. 23, 2004

(54) Process for processing sludge to a granulate

(75) Inventor: Peter Knoer, Kreuzlingen (CH)

Correspondence Address: Ladas & Parry, 26 West 61st Street, New York, NY, 10023, US

(73) Assignee: INNOPLANA UMWELTTECHNIK AG

(21) Appl. No.: 10/391,842

(22) Filed: Mar. 19, 2003

(51) Int. Cl. B02C 19/12

(52) U.S. Cl. 241/23; 241/65

(57) ABSTRACT

On processing pasty materials, the material is conveyed with a relatively high dry fraction of 40 to 75% through the holes (62) of the perforated plate (42) of a granulator, in that a feed element (50), forming with the perforated plate (42) a wedge-shaped gap space (61), strokes with its trailing edge (53) over the perforated plate (42). The material strands (63) pressed out of the holes (62) are cut off by a knife-like separating device (64) stroking over the discharge-side surface of the perforated plate (42). Thus, particles of a particularly small size can be produced with a relatively low energy cost from the sludge and without the granulator being blocked by a damming up of fibres, e.g. in the form of hair contained in the sludge.

### BACKGROUND OF THE INVENTION

The invention relates to a process for processing sludge, particularly sewage sludge from municipal sewage works to a granulate of identical particle size, with pre-evaporation by heating the sludge, producing a granulate from the pre-evaporated material and afterdrying the granulate, the material being pre-evaporated to a dry fraction of more than 40% and during granulation is fed through the holes of a perforated plate.

The invention also relates to a process plant for performing the process.

EP-B-781741 discloses a process of the aforementioned type, where the sewage sludge is pre-evaporated in a thin film evaporator to a dry fraction of 40 to 60% and subsequently is extruded through holes arranged in screen-like manner of a not further described granulator in the form of numerous strands. Admittedly reference is made to a hole width or diameter of 3 to 10 mm, preferably 5 to 6 mm, but it has been found that with a relatively high dry fraction of 40 to 60% and a hole width of less than 5 mm the flow resistance in the holes and therefore the drive resistance of the granulator is very high. In addition, there is a considerable drive resistance resulting from the squeezing of the pasty sludge in the area between the holes. However, the known process is more particularly unsuitable for processing municipal sewage sludge in the case where a granulate with a particle size of less than 5 mm is to be produced. In this case as a result of the proportion of hair contained in municipal sewage a felt-like barrier layer is formed on the perforated plate of the granulator and prevents further sludge conveying.

An example for the implementation of a granulator with significant material squeezing and the risk of the blocking of holes by hair is known from DE 928 686.

In order to produce a granulate with a small particle size of less than 5 mm, such as is required for use as fuel or fertilizer for meadows, the known process requires a subsequent comminuting of the granulate, associated with the production of dust, following the drying thereof. As a uniform particle size cannot be obtained, the material has to be subsequently classified, accompanied by a corresponding additional apparatus cost and returned to the process to a significant extent in a process stage upstream of the granulator.

The problem of the invention is to provide an operationally reliable process of the aforementioned type which is also suitable for the processing of sludge containing fibrous components, such as e.g. sewage sludge from communal sewage systems which, with relatively limited apparatus costs and low operating costs, permits the production of a particularly fine-grained granulate of high density and abrasion resistance with a particle size of less than 5 mm.

### DESCRIPTION OF THE INVENTION

In the case of a process of the aforementioned type, the invention solves this problem in that the feeding through the holes of the perforated plate takes place by means of at least one feed element stroking over the feed-side surface of the perforated plate and forming therewith a wedge-shaped gap space, so that the pressure for feeding through the perforated plate is produced by the stroking movement in the wedge-shaped gap space, the material strands forced out of the holes being cut off by a knife-like separating device stroking over the discharge-side surface of the perforated plate.

### BRIEF DESCRIPTION OF THE DRAWINGS

The invention is described in greater detail hereinafter relative to the attached drawings, wherein show:

FIG. 1 A diagrammatic representation of an embodiment of a plant for performing the process.

FIG. 2 A radial section through the granulator of the process plant of FIG. 1.

FIG. 3 A perspective view of a feed element-carrying rotor.

FIG. 4 A granulator according to the invention in a perspective view of its parts partly separated from one another.

FIG. 5 A perspective plan view of the rotor of FIG. 3.

FIG. 6 A perspective view of the granulator casing.

FIG. 7 A diagrammatic view of the association between the feed member and separating device corresponding to a development of the said arrangement on a circular path.

### DETAILED DESCRIPTION OF AN EMBODIMENT

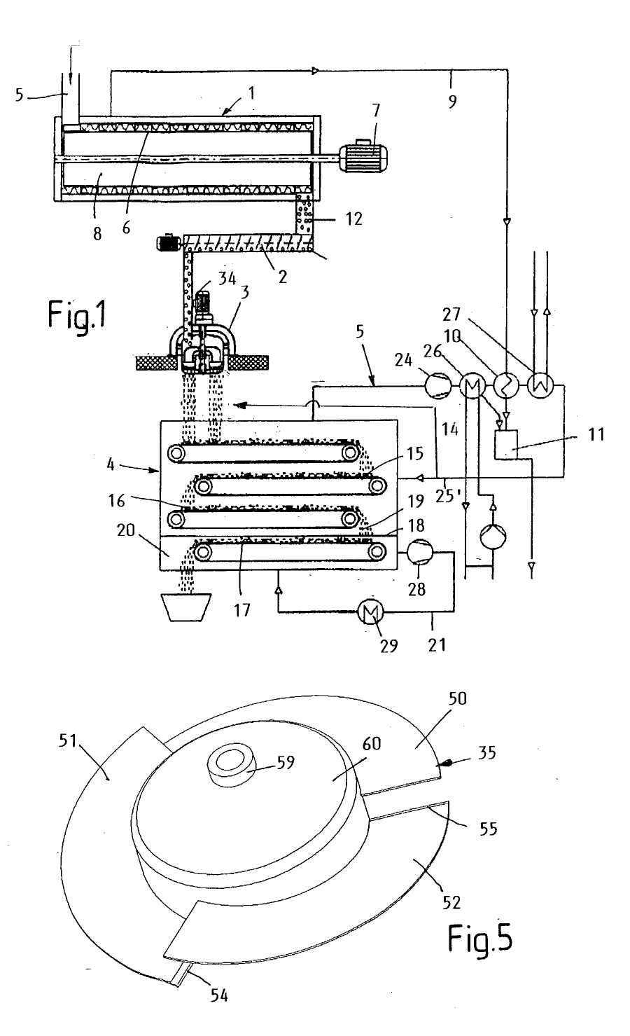

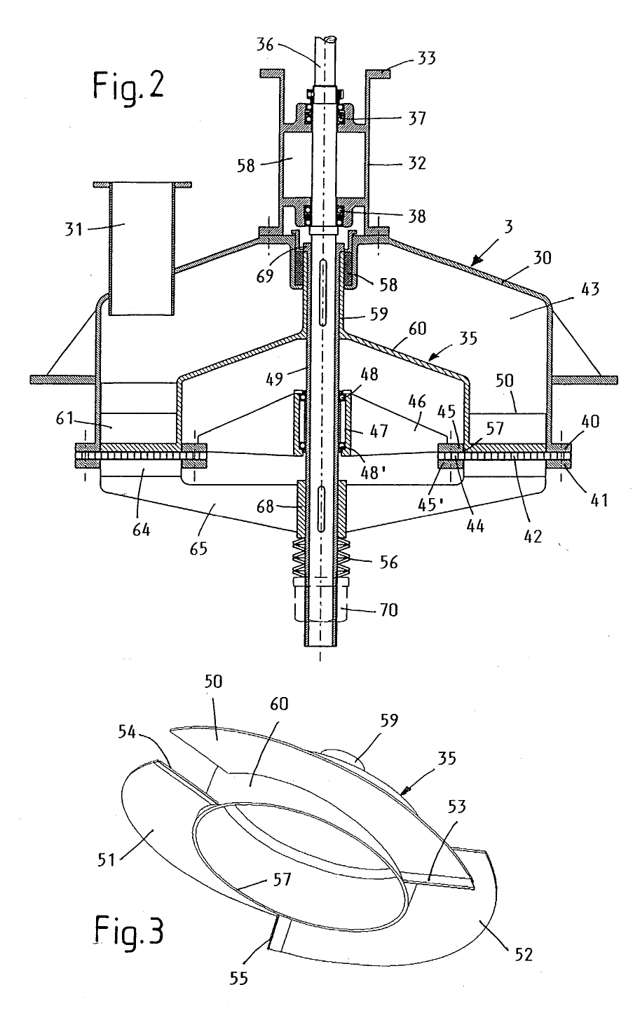

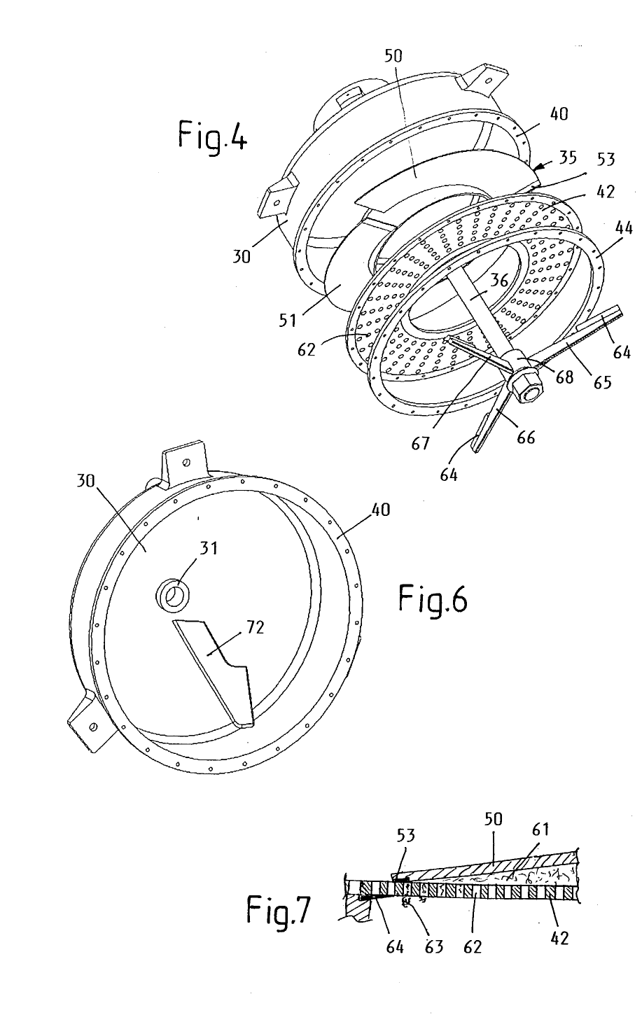

As shown in FIG. 1, the process plant essentially comprises a thin film evaporator 1, a screw conveyor 2, a granulator 3, a belt dryer 4 and a duct system 5 for carrying gas flows with heat recovery.

The sludge which is pre-thickened e.g. in a not shown perforated belt press to a dry fraction of 18 to 30% is supplied by means of the connecting piece 5 to the thin film evaporator 1 and is distributed therein on its heated drum surface 6 by large-area feed members connected to a drive 7. The evaporated moisture is supplied in a vapour flow via line 9 to a heat exchanger 10 acting as a condenser and is collected in a condensate tank 11.

The thus pre-evaporated sludge leaves the thin film evaporator 1 with a pasty consistency corresponding to a dry fraction of 40 to 75% by means of an outlet connection 12, which issues into a screw conveyor 2, which conveys the sludge into a granulator 3. As a result of this conveying a damming up can occur in granulator 3, so that a pressure builds up in the latter. However, the pressure in the granulator 3 can additionally or also result through the operation of the thin film evaporator 1 with overpressure. The material formed from the sludge and leaving the granulator 3 as particles of uniform size can, as a result of the invention, have a particle size which is significantly smaller than 5 mm and is e.g. 3 mm.

Before the material trickles onto the first belt 3 of the belt dryer 4, it can be exposed to a hot air flow for further drying purposes, said air flow being e.g. branched via line 14 from the dry air inflow line 25′ of the belt dryer 4 and subsequently passes together with the particle flow into the belt dryer 4.

The belt dryer 4 comprises superimposed, air-permeable conveying belts 13 to 17. The lowermost 17 of the air-permeable conveyor belts 13 to 17 is located in a cooling area 20 separated by a partition 18 and a not shown lock 19 and through which there is a flow of cooling air circulating through line 21.

The dry fraction of the product leaving the belt dryer 4 is approximately 90%. Its particles can have a uniform size as small as e.g. 2 mm, so that the product of sewage sludge drying offers new possibilities of use, e.g. as a fertilizer for golf courses or as a pneumatically feedable fuel material. The particles are sufficiently firm to prevent an undesired production of dust.

The pre-evaporation of the sludge to a relatively high sludge consistency with a dry fraction of up to 75% is preferable for the granulator described in greater detail hereinafter. It can be obtained with relatively limited energy expenditure, because the thermal energy drawn off together with the steam via line 9 is supplied by means of the heat exchanger 10 to the belt dryer 4, where there is a heat exchange with the dry gas flow of belt dryer 4 cooled in the cooler 26.

The air used for drying in the hot, upper part of the belt dryer 4 circulates by means of a blower 24 through line 25, passing through a cooler 26, as well as the heat exchanger 20, serving as a condenser for the gas flow from the thin film evaporator 1, and a heater 27. The circulation of the cooling air flow through line 21 takes place by means of a blower via an air cooler 29.

The optimum dryness content for granulation is dependent on the nature of the material and should therefore be determined in each case. A high dryness content also aids the action of granulator 3 on cutting through the fibres or hair on passing out of the granulator. It has surprisingly been found that even with a particularly low moisture content of 60 to 75% it is possible to granulate with a hole width of 2 to 4 mm without the holes becoming blocked. This is due to the thixotropic behaviour of the sludge moved in the wedge gap 61.

The granulator 3 has a bell-shaped casing 30 with a laterally positioned, upper inlet connection 31 for the sludge supplied from the pre-evaporator 1. A connecting piece 32 extending centrally upwards from the casing 30 is used for the connection, by means of an end flange 33, of a rotary drive 34 diagrammatically shown in FIG. 1 for driving the rotor 35 enclosed in the casing 30 and for guiding the driving shaft 36 by means of two bearings 37, 38.

Downwardly the bell-shaped casing 30 terminates in a flange 40. Between the latter and a flange ring 41 is held a circular perforated plate or disk 42, which bounds in the downwards direction the sludge chamber 43 limited by the bell-shaped rotor 35. The inner rim 44 of the perforated plate 42 is held between a pair of flanges 45,45′. One of them is connected by radially directed supporting arms 46 to a hub 47, which by radial bearings 48,48′0 is supported on a tension sleeve 49 surrounding the central driving shaft 36. However, an internal support of the perforated plate 42 can be avoided through its flexurally rigid construction, e.g. by it passing slightly conically upwards in the direction of shaft 36.

The rotor 35 inwardly bounding the sludge chamber 43 carries on the circumference of a bell-shaped hub body 60, e.g. three rotor blade-like feed elements 50, 51, 52, whose knife edge-like trailing edge 53, 54, 55 engages under the tension of a spring mechanism 56, e.g. constructed as cup springs, on the feed-side surface of the perforated plate 42. The trailing edge 53-55 extends over the entire width, provided with holes 62, of the surface of the perforated plate 42 facing the sludge chamber 43. The lower, circumferential edge 57 of the bell-shaped hub body 60 of rotor 35 engages on the perforated disk 42 and on the flange 45, so that the sludge chamber 43 is sealed radially inwards. A further sealing of the sludge chamber 43 is provided by a ring seal 58, which surrounds, e.g. as a packing box the circumference of a cylindrical hub part 59 into which extends the bell-shaped hub body 60 of rotor 35.

The rotor blade-like feed elements 50, 51, 52, as a result of their particularly small pitch angle, especially in the vicinity of the narrowest wedge gap area, form with the feed-side surface of the perforated disk 42 an acute angle, so that they form with the disk 42 a wedge gap-like narrowing feed chamber 61. The pasty sludge is moved in the direction of the gap narrowing by the relative movement between the feed elements 50, 51, 52 and the perforated plate 42 and consequently is exposed there to an adequate pressure to be forced through the relatively small holes 62 of perforated plate 42. The stirring movement acting in the feed chamber 61 on the sludge, as a result of the thixotropic nature thereof, improves its flow behaviour, so that the feeding through the narrow holes is facilitated and despite the high sludge consistency corresponding to a dry fraction of preferably 60 to 70%, this takes place with a relatively low pressure gradient. The material strands 63 passing out of the holes 62 as a result of the extensive pre-evaporation to a dry fraction of up to 75%, have a strength aiding their granulate-forming separation from the perforated plate 42 by means of a separating device 64, including the cutting through of enclosed fibres.

The at least one separating device 64 engaging in doctor blade-like manner on the delivery-side surface of the perforated plate 42 is in each case connected by a separating arm 65, 66, 67 to a hub part 68, which is in displaceable drive engagement with the driving shaft 36 and its surrounding tension sleeve 49. A spring mechanism 56, e.g. comprising cup springs engaging on a srew ferrule 70, the treads of which engage the tension sleeve 49, presses the knife-like separating devices 64 elastically against the delivery-side surface of the perforated plate 42. The force of the spring mechanism 56 is transmitted via the tension sleeve 49 and its upper flange 69 also to the hub of the rotor 35, so that the perforated plate 42 is gripped between the rotor blade-like feed elements 50, 51, 52 and the separating devices 64 under the tension of the spring mechanism 56.

In order to prevent a carrying along through the feed elements 50, 51, 52 of the pasty sludge filling the sludge chamber 43, to the latter is fixed a baffle-like guide element 72, whose inclined position deflects the inflowing sludge in the direction of the perforated plate 42, so as to pass in the gap space 61 between the feed elements 50, 51, 52 and the perforated disk 42.

Unlike in the described embodiment, in a kinematic reversal, the feed elements can be fixed in not shown manner to the casing 30 of granulator 3 and instead of this the perforated disk 42 can be connected to the driving shaft 36. In this case also the separating device 64 can be firmly connected to the casing 30.

It is also possible to drive a separating device for the cutting through of the granulate strands 63 fed out of the perforated disk 42, independently of the feed elements. It e.g. comprises twelve radially directed knife elements, which are provided on a common knife support and which are moved backwards and forwards by in each case 30∅ in the circumferential direction of the perforated disk by an externally positioned lifting drive.

1. Process for processing sludge, particularly sewage sludge from municipal sewage plants to a granulate of identical particle size, with pre-evaporation by heating the sludge, producing a granulate from the pre-evaporated material and afterdrying the granulate, the material being pre-evaporated to a dry fraction of more than 40% and fed during granulation through the holes of a perforated plate, wherein feeding through the holes (62) of the perforated plate (42) takes place by means of at least one feed element (50, 51, 52) which strokes over the feed-side surface of the perforated plate (42) and forms therewith a wedge-shaped gap space (61), so that the pressure for feeding through the perforated plate (42) is produced by the stroking movement in the wedge-shaped gap space (61), the material strands (63) forced out of the holes (62) being cut off by a knife-like separating device (64) stroking over the discharge-side surface of the perforated plate (42).

2. Process according to claim 1, wherein the material is granulated with a dry fraction of 40 to 75%.

3. Process according to claim 2, wherein the material is granulated with a dry fraction of 60 to 70%.

4. Process according to claim 1, wherein the feeding through the holes (62) of the perforated plate (42) takes place with an identical hole width in the range 2 to 4 mm.

5. Process according to claim 4, wherein the material strands (63) are cut off with a length of 2 to 4 mm.

6. Process according to claim 1, wherein the feed pressure in the wedge-shaped gap space (61) is formed in addition to a pressure with which the material is supplied to the at least one feed element (50, 51, 52), so that between the feed-side and discharge-side surface of the perforated plate (42) there is a pressure difference to which is added the supply pressure.

7. Process according to claim 1, wherein the cut off granulate particles are exposed to a heated gas flow on passing through a drop path leading to an afterdryer (4).

8. Process plant for performing the process according to claim 1 with a pre-evaporator (1) having an inlet duct (5) and an outlet duct (12), a granulator (3), which is connected by means of a conveyor (12, 2) to the pre-evaporator (1) and with an afterdryer (4) located below the granulator (3), which has at least one feed element (50, 51, 52) enclosed within its casing (30) and a perforated plate (42) provided with a feed-side and discharge-side surface, wherein the at least one feed element (50, 51, 52) extends from a trailing edge (53, 54, 55) engaging on the feed-side surface of the perforated plate (42) with a shallow angle (60), so that it forms with the surface of the perforated plate (42) a feed pressure-producing wedge gap (61), as well as a doctor blade-like separating device (64) engaging on the discharge-side surface of the perforated plate (42) for the separation of the granulate strands (63) from the perforated disk (42) and for a relative movement between the feed element and the perforated plate a drive is connected to one of these.

9. Process plant according to claim 8, wherein at least one feed element (50, 51, 52) is provided in rotor blade-like manner on a hub body (60) of a rotor (35) and engages with its radially extending trailing edge (53, 54, 55) on a circular perforated plate (42) surrounding with distance the driving shaft (36) of the rotor (35), a guide element (72) being arranged in baffle-like, fixed manner in the granulator casing (30) surrounding the rotor (35).

10. Process plant according to claim 9, wherein the at least one doctor blade-like separating device (64) engaging on the discharge-side surface of the perforated plate (42) is connected to a hub part (68), which is in driving connection with the driving shaft (36).

11. Process plant according to claim 10, wherein a cylindrical hub element (59) of a rotor (35) carrying feed elements (51, 51, 52) and the hub part (68) of the separating device (64) are axially displaceable on the driving shaft (36) counter to the pressure of a spring mechanism (56) surrounding the same, so that the feed element (50, 51, 52) and the separating device (64) engage on both sides of the perforated plate (42) under the pressure of said spring mechanisms (56).

12. Process plant according to claim 11, wherein the cylindrical hub element (59) of the rotor (35) and the hub part (68) of the separating device (64) are supported by a common tension sleeve (49) and are clamped between an end flange (69) of the tension sleeve (49) and the spring mechanism (56).

13. Process plant according to claim 10, wherein the cutting edge of the doctor blade-like, engaging separating device (64) is displaced in trailing manner relative to the trailing edge (53, 54, 55) of the feed element (50, 51, 52), so that the length of cut of the particles formed by cutting off is determined by the magnitude of the trailing distance.

14. Process plant according to claim 8, wherein the trailing distance corresponds to a length of cut of less than 5 mm.

15. Process plant according to claim 8, wherein the holes (62) of the perforated plate (42) have a uniform width of less than 5 mm.

16. Process plant according to claim 8, wherein the holes (62) of the perforated plate (42) have a uniform width of 3 mm.
